(19) United States
(12) Patent Application Publication
(10) Pub. No.: US 2026/0267772 A1
(43) Pub. Date: Sep. 10, 2026

(54) SYSTEM AND METHOD FOR AUTONOMOUS VERIFICATION AND VALIDATION OF AN INTERACTIVE DEVICE UNDER TEST (DUT)

(71) Applicant: SGBI Inc., Sunnyvale, CA (US)

(72) Inventors: Aronin Ponnappan, Sunnyvale, CA (US); Akhil Asokan, Manchester (GB); Asif Dadamiya Ismail, Palakkad (IN)

(21) Appl. No.: 19/665,040

(22) Filed: May 1, 2026

Related U.S. Application Data
(63) Continuation-in-part of application No. 18/626,004, filed on Apr. 3, 2024, now Pat. No. 12,617,079.

(51) Int. Cl. G06F 11/3604

(52) U.S. Cl. CPC G06F 11/3608

(57) ABSTRACT

Disclosed are a system and a computer-implemented method for automated testing of an interactive device under test (DUT). The method includes receiving input artifacts describing the functional behavior of the DUT and processing them using one or more artificial intelligence models to extract interface elements and expected outcomes. A structured human-readable test logic representation is generated and converted into automation commands for execution using one or more interaction mechanisms. The method further includes observing device states using a perception subsystem and validating the device states before executing each interaction action. A next interaction action is generated at runtime based on the validated device states. Outcomes of executed actions are validated to detect abnormalities based on deviations from expected outcomes. Evidence data corresponding to detected abnormalities is captured, and a structured report is generated to represent the abnormalities and associated evidence.

### FIELD OF THE INVENTION

The specification is generally directed toward a system and method for automated verification and validation of interactive electronic systems. More particularly, but not limited to, an autonomous artificial intelligence-driven platform for verification and validation of human-machine interfaces (HMIs) and other interactive systems through the coordinated use of perception systems, reasoning engines, and physical and virtual interaction mechanisms.

### BACKGROUND

Modern electronic products increasingly incorporate sophisticated human-machine interfaces (HMIs) to enable user interaction with digital systems. Such interfaces may include, for example, touchscreens, physical buttons, rotary controls, gesture recognition systems, voice interfaces, proximity sensing inputs, and hybrid hardware-software control surfaces. Ensuring reliable operation of these interfaces requires comprehensive verification and validation across a wide range of user interaction scenarios, environmental conditions, peripheral configurations, firmware versions, software revisions, and device states. As device complexity continues to increase, the number of required test cases for a single interactive device may range from hundreds to millions across development, manufacturing validation, certification testing, maintenance, and refurbishment phases.

Despite advances in software automation tools, verification and validation of interactive systems remain resource-intensive and difficult to scale. Conventional approaches suffer from several technical and operational limitations. First, the creation of test scripts is time-consuming and requires significant domain expertise. Existing automation frameworks rely on engineers to manually design, implement, and validate test scenarios. For example, a relatively short automated test sequence that represents only a few minutes of user interaction may require substantially longer development time from a skilled automation engineer. For complex systems such as point-of-sale terminals, automotive infotainment systems, avionics control panels, medical diagnostic devices, smartphones, wearables, and smart appliances, the number of required test cases can increase dramatically over the product lifecycle. This reliance on specialized human expertise introduces bottlenecks in development pipelines and slows the pace of product validation and release. Second, conventional automation scripts require continuous maintenance. Test scripts are typically implemented as static, predefined sequences that depend on fixed interface elements, screen layouts, application states, or hardware assumptions. Even minor changes to user interfaces, firmware, operating systems, hardware components, or peripheral configurations can cause existing scripts to fail or produce inconsistent results. As a result, engineering resources must be continuously allocated to update and maintain automation scripts. In fast-paced development environments, the effort required to maintain scripts may exceed the time available, leading organizations to revert to manual testing, increasing costs and reducing reliability. Third, the quality of test logic is highly dependent on human expertise. In conventional systems, the completeness and reliability of test coverage are influenced by the experience, domain knowledge, and thoroughness of individual engineers. Variations in expertise across teams can lead to inconsistent test coverage, missed edge cases, and inconsistent validation standards. This human-dependent variability reduces the overall reliability and repeatability of automated testing outcomes. Fourth, software-only automation tools are insufficient for a significant portion of testing scenarios involving physical interaction.

Many existing frameworks operate solely at the software layer by simulating user inputs such as touch, keyboard, or application programming interface (API) interactions. However, a substantial percentage of real-world testing scenarios require physical interaction with hardware components to replicate user behavior accurately. For example, testing of retail point-of-sale systems may require card insertion or tapping, barcode scanning, receipt printing, and validation of peripheral connectivity. Similarly, automotive and avionics systems often require interaction with physical sensors, actuators, and hardware-in-the-loop configurations. Medical devices may require testing under real-world conditions and compliance with human-factor validation protocols. These scenarios cannot be reliably addressed using software-only tools, necessitating manual testing or specialized hardware setups, both of which increase complexity and cost.

Fifth, there is a lack of unified testing platforms capable of addressing both software and hardware interaction requirements. Existing solutions are typically fragmented, with software automation frameworks focusing on digital interfaces and robotic or hardware testing systems addressing physical interactions. These systems often operate independently and rely on static scripts, requiring significant manual configuration and coordination. Consequently, organizations must maintain multiple testing infrastructures, leading to inefficiencies, increased integration complexity, and higher operational overhead.

In view of the foregoing limitations, there is a need for improved systems and methods that enable efficient, scalable, and reliable verification and validation of interactive electronic systems.

The present invention relates generally to systems and methods for automated verification and validation of interactive electronic systems. More particularly, the invention relates to an autonomous, artificial intelligence-driven platform for the verification and validation of human-machine interfaces (HMIs) and other interactive systems through the coordinated use of perception systems, reasoning engines, and both physical and virtual interaction mechanisms.

Thus, in view of the above, there is a long-felt need in the industry to address the deficiencies and inadequacies outlined.

Further limitations and disadvantages of conventional approaches will become apparent to one of skill in the art through the comparison of the described systems with some aspects of the present disclosure, as outlined in the remainder of the present application and with reference to the drawings.

### SUMMARY OF THE INVENTION

An aspect of the present invention relates to a system for autonomous verification and validation of an interactive device under test (DUT). The system includes a processor configured to generate a plurality of test procedures and to determine one or more interaction actions based on one or more input artifacts describing the functional behavior of the DUT. The processor is configured to obtain runtime data describing the state of the DUT using at least one of: a camera-based observation, a screen capture, an application programming interface (API), one or more telemetry signals, and physical feedback. Examples of the physical feedback include, but are not limited to, buttons, knobs, indicator lights, or haptic inputs. The processor is configured to validate the runtime data to determine the DUT's current state before executing an interaction action. The processor is configured to compare the current state with an expected contextual state. The processor is configured to determine, at runtime, the next interaction action based on the current state and the expected contextual state. The next interaction action is generated without reliance on a predefined test script. The processor is configured to perform one or more interactions with the DUT using an interaction mechanism. The processor is configured to validate the outcome of one or more interactions based on updated runtime data. The processor is configured to detect one or more abnormalities or deviations between an expected outcome and an observed outcome. The processor is configured to capture an evidence data corresponding to the one or more abnormalities. The processor is configured to generate a structured report based on the one or more abnormalities and the evidence data.

In an aspect, the processor is further configured to store one or more device interaction parameters and one or more execution outcomes, and adapt the next interaction action based on the one or more abnormalities and the one or more execution outcomes in a continuous closed-loop execution cycle.

In an aspect, the processor is further configured to implement a perception-reasoning-action loop comprising an observe-interpret-decide-act-validate-learn cycle.

In an aspect, the processor is further configured to perform object detection, optical character recognition, and interface element classification.

In an aspect, the processor is further configured to select the interaction mechanism based on output from an artificial intelligence reasoning engine.

In an aspect, the processor is configured to enable the artificial intelligence reasoning engine to modify an execution path based on deviations between the expected outcome and the observed outcome.

Another aspect of the present invention relates to a computer-implemented method for automated testing of an interactive device under test (DUT). The computer-implemented method includes a step of receiving one or more input artifacts that describe the functional behavior of the DUT. The computer-implemented method includes a step of processing the one or more input artifacts using one or more artificial intelligence models to extract one or more interface elements and one or more expected outcomes. The computer-implemented method includes a step of generating a structured human-readable test logic representation. The computer-implemented method includes a step of converting the structured human-readable test logic representation into one or more automation commands. The computer-implemented method includes a step of executing the one or more automation commands using one or more interaction mechanisms. The computer-implemented method includes a step of observing one or more device states using a perception subsystem. The computer-implemented method includes a step of validating the one or more device states before execution of each interaction action. The computer-implemented method includes a step of generating a next interaction action at runtime based on the one or more device states, without executing a predefined script. The computer-implemented method includes a step of validating one or more outcomes of executed actions and detecting one or more abnormalities based on one or more deviations from the one or more expected outcomes. The computer-implemented method includes a step of capturing an evidence data corresponding to the one or more abnormalities. The computer-implemented method includes a step of generating a structured report based on the one or more abnormalities and the evidence data.

In an aspect, the computer-implemented method includes a step of adapting the next interaction action based on the one or more abnormalities and one or more execution outcomes in a continuous closed-loop execution cycle.

In an aspect, the computer-implemented method includes a step of switching between the one or more interaction mechanisms during execution.

In an aspect, the computer-implemented method includes a step of recording one or more execution outcomes and updating a knowledge base with one or more extracted interaction parameters.

In an aspect, the computer-implemented method includes a step of identifying one or more device behavior patterns from the one or more execution outcomes.

In an aspect, the computer-implemented method includes a step of modifying an execution path based on the deviations between the one or more expected outcomes and an observed outcome.

Another aspect of the present invention relates to a system for autonomous interaction with and evaluation of a device under test (DUT). The system includes a processor configured to receive multimodal input data representing a current state of the DUT. The processor is configured to determine a contextual representation of the current state of the DUT. The processor is configured to validate the contextual representation against one or more expected conditions before execution of an interaction. The processor is configured to generate, at runtime, a next interaction action for the DUT based on the current state. The next interaction action is not derived from a predefined sequence of scripted steps. The processor is configured to execute the next interaction action using an interaction mechanism. The processor is configured to receive an updated multimodal input data corresponding to an outcome of the next interaction action. The processor is configured to evaluate the outcome by comparing the updated multimodal input data with one or more expected outcomes. The processor is configured to detect one or more abnormalities associated with the DUT. The processor is configured to capture an evidence data corresponding to the one or more abnormalities. The processor is configured to generate a structured report based on the one or more abnormalities and the evidence data.

In an aspect, the processor is configured to store execution data and adapt the next interaction action based on the one or more abnormalities and the execution data in a continuous closed-loop execution cycle.

In an aspect, the processor is configured to switch between the one or more interaction mechanisms during an execution.

In an aspect, the processor is configured to record one or more execution outcomes and update a knowledge base with one or more extracted interaction parameters.

In an aspect, the processor is configured to identify one or more device behavior patterns from the one or more execution outcomes.

In an aspect, the processor is configured to modify an execution path based on one or more deviations between the one or more expected outcomes and an observed outcome.

Examples of the multimodal input data include visual data, interface data, telemetry data, and physical feedback data. Examples of the evidence data include a visual record, an interaction log, and a system data.

Accordingly, another advantage of the present invention is that it employs an adaptive hybrid testing architecture in which an artificial intelligence engine dynamically determines an optimal method for observing and interacting with a device under test by selectively utilizing one or more of physical robotic interaction, software-simulated interaction, screen capture or display interception techniques, camera-based visual perception systems, or combinations thereof.

Accordingly, another advantage of the present invention is that it is applicable across a wide range of industries and device categories including consumer electronics, mobile devices, smartphones, tablets, wearables, automotive and avionics systems, medical equipment, industrial control systems, retail point-of-sale systems, banking terminals and ATMs, associated applications, smart appliances, and other interactive computing systems requiring verification and validation of human-machine interfaces.

Other embodiments and advantages will become readily apparent to those skilled in the art upon viewing the drawings and reading the detailed description hereafter, all without departing from the spirit and the scope of the disclosure. The drawings and detailed descriptions presented are to be regarded as illustrative in nature and not in any way as restrictive.

### BRIEF DESCRIPTION OF THE DRAWINGS

The accompanying drawings illustrate the embodiments of systems, methods, and other aspects of the disclosure. Any person of ordinary skill in the art will appreciate that the illustrated element boundaries (e.g., boxes, groups of boxes, or other shapes) in the figures represent an example of the boundaries. In some examples, one element may be designed as multiple elements, or multiple elements may be combined into a single element. In some examples, an element shown as an internal component of one element may be implemented as an external component in another, and vice versa. Furthermore, the elements may not be drawn to scale. Reference numerals may be selectively repeated across images for clarity or emphasis.

Various embodiments will hereinafter be described in accordance with the appended drawings, which are provided to illustrate, not limit, the scope, wherein similar designations denote similar elements, and in which:

FIG. 1 is a schematic block diagram showing an exemplary system for implementing the autonomous verification and validation of an interactive device under test (DUT), according to an embodiment of the present invention.

FIG. 2 is a block diagram illustrating a plurality of user input sources, a QUACO test studio, an AI reasoning engine (AI brain), a hybrid execution framework, a device under test, a perception system, and a knowledge base and learning system, according to an embodiment of the present invention.

FIG. 3 illustrates an AI-driven test generation pipeline, according to an embodiment of the present invention.

FIG. 4 illustrates a flow diagram of an autonomous test execution loop, according to an embodiment of the present invention.

FIG. 5 illustrates a flow diagram of a hybrid interaction mode switching, according to an embodiment of the present invention.

FIG. 6 illustrates a block diagram of a Multimodal perception system, according to an embodiment of the present invention.

FIG. 7 illustrates a block diagram of a knowledge base and learning architecture, according to an embodiment of the present invention.

FIG. 8 illustrates a block diagram of a deployment configuration of the present system, according to an embodiment of the present invention.

FIG. 9 is a flowchart of a method for automated testing of an interactive device under test (DUT), according to an embodiment of the present invention.

### DETAILED DESCRIPTION

The present description is best understood with reference to the detailed figures and description set forth herein. Various embodiments of the present system and method have been discussed with reference to the figures. However, those skilled in the art will readily appreciate that the detailed description provided herein with respect to the figures is merely for explanatory purposes, as the present system and method may extend beyond the described embodiments. For instance, the teachings presented and the needs of a particular application may yield multiple alternative and suitable approaches to implement the functionality of any detail of the present systems and methods described herein. Therefore, any approach to implement the present system and method may extend beyond certain implementation choices in the following embodiments.

According to an embodiment herein, the methods of the present invention may be implemented by performing or completing manually, automatically, and/or a combination of thereof. The term “method” refers to manners, means, techniques, and procedures for accomplishing any task, including, but not limited to, those manners, means, techniques, and procedures either known to the person skilled in the art or readily developed from existing manners, means, techniques, and procedures by practitioners of the art to which the present invention belongs. The persons skilled in the art will envision many other possible variations within the scope of the present system and method described herein.

The present invention relates to systems and methods for autonomous verification and validation of interactive electronic systems and human-machine interfaces (HMIs).

The present system addresses limitations of conventional testing approaches by providing an integrated platform that autonomously generates, executes, adapts, and improves test procedures. The system can monitor device behavior in real time, identify abnormalities or functional deviations, capture evidence associated with detected issues, and generate structured reports indicating system performance and detected defects.

At the core of the system is an artificial intelligence reasoning engine configured to function as a central decision-making component. The artificial intelligence reasoning engine controls test planning, observation selection, interaction selection, execution management, anomaly detection, report generation, and learning operations. In operation, the artificial intelligence reasoning engine continuously evaluates the state of the DUT and determines subsequent actions based on observed conditions to enable adaptive and non-scripted test execution.

In some embodiments, the artificial intelligence reasoning engine operates on local computing infrastructure, including, but not limited to, a robotic testing unit, workstation, laptop, personal computer, or on-premises computing system. The system may optionally interface with remote or cloud-based infrastructure for purposes such as model training, data aggregation, or synchronization across multiple systems. However, the system is configured to perform inference and decision-making operations locally to reduce dependency on continuous network connectivity.

The reasoning engine may utilize one or more artificial intelligence models, including language models, vision models, multimodal models, and action-generation models. These models enable the system to interpret input data, generate test procedures, and determine interaction actions. Input data may include natural language descriptions, product documentation, testing specifications, regulatory requirements, historical execution data, or previously acquired knowledge of device interactions.

The system further includes one or more perception modules configured to obtain runtime information representing the DUT's state. The perception modules may include camera-based vision systems, screen capture mechanisms, optical character recognition (OCR) components, sensor-based inputs, application programming interface (API) status feeds, telemetry signals, or combinations thereof. These modules enable the system to interpret device state information across multiple modalities.

The system also includes interaction modules configured to perform interactions with the DUT. Physical interactions may be executed using robotic actuators that engage interface elements such as touchscreens, buttons, knobs, sliders, and other control surfaces. Virtual interactions may be performed using software-based input mechanisms, including simulated touch input, keyboard input, pointer control, gesture simulation, or other programmatic interaction techniques.

In some embodiments, the system operates using a hybrid execution framework in which the artificial intelligence reasoning engine dynamically selects an observation method and an interaction mechanism based on contextual conditions. Such conditions may include device accessibility, availability of software-level interaction access, visibility of interface elements, interaction latency, safety considerations, and execution efficiency.

The system further incorporates learning mechanisms configured to improve performance over time based on execution data. The system may store execution outcomes, interaction parameters, detected abnormalities, and contextual information, and utilize such data to refine subsequent decision-making processes. Through iterative operations, the system develops a knowledge base that represents device behavior, interface characteristics, and testing strategies. The knowledge base may be maintained locally and, in some embodiments, selectively shared across multiple systems.

The disclosed platform enables automated testing of interactive systems utilizing a wide range of human interaction modalities. These include touch-based interfaces such as touchscreens, buttons, and mechanical controls; touchless interfaces such as gesture-based or proximity-based systems; voice-based interfaces, including speech-driven commands; and other interaction paradigms. The system is adaptable to various forms of user interaction and device configurations.

By integrating artificial intelligence-driven reasoning, multimodal perception, physical interaction capabilities, software-based interaction mechanisms, and adaptive learning, the invention enables efficient and scalable verification and validation of interactive systems. The system reduces reliance on manual test development, improves test execution consistency, and enables testing scenarios that are not addressable with conventional software-only automation tools.

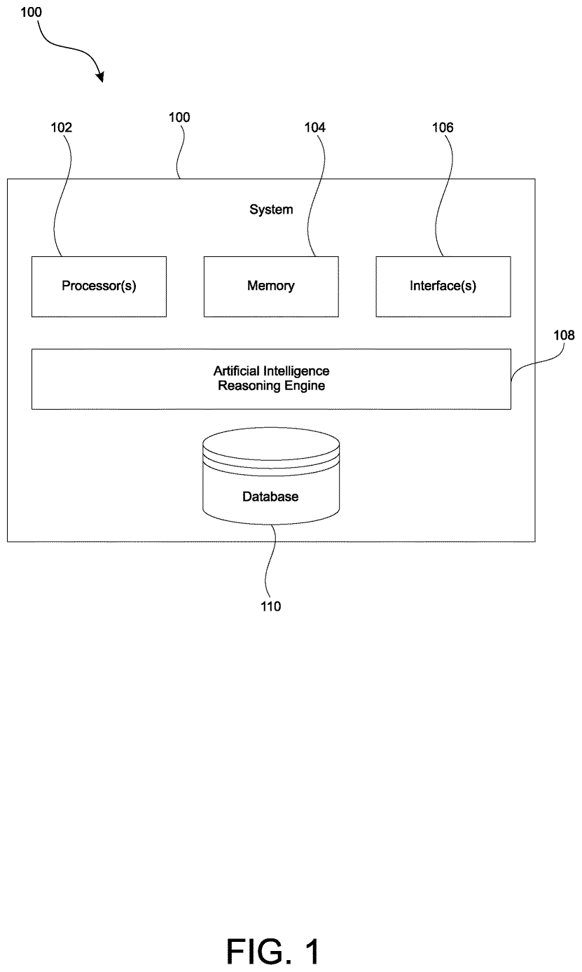

FIG. 1 is a schematic block diagram showing an exemplary system 100 for implementing the autonomous verification and validation of an interactive device under test (DUT), according to an embodiment of the present invention. In an embodiment, the system 100 may include one or more processor(s) 102. The one or more processor(s) 102 may be implemented as one or more microprocessors, microcomputers, microcontrollers, digital signal processors, central processing units, logic circuitries, and/or any devices that process data based on operational instructions. Among other capabilities, the one or more processor(s) 102 may be configured to fetch and execute computer-readable instructions stored in a memory 104 of the system 100. The memory 104 may be configured to store one or more computer-readable instructions or routines in a non-transitory computer-readable storage medium, which may be fetched and executed to create or share data packets over a network service. The memory 104 may include any non-transitory storage device, including, for example, volatile memory such as Random-Access Memory (RAM) or a non-volatile memory such as an Erasable Programmable Read Only Memory (EPROM), flash memory, and the like.

In an embodiment, the system 100 may include an artificial intelligence reasoning engine 108 that may be implemented as a combination of hardware and programming (for example, programmable instructions) to implement one or more functionalities of the artificial intelligence reasoning engine 108. As described herein, such combinations of hardware and software may be implemented in several different ways. For example, the programming for the artificial intelligence reasoning engine 108 may comprise processor-executable instructions stored on a non-transitory machine-readable storage medium, and the hardware for the artificial intelligence reasoning engine 108 may comprise a processing resource (e.g., one or more processors) to execute such instructions. In the present examples, the machine-readable storage medium may store instructions that, when executed by the processing resource, implement the artificial intelligence reasoning engine 108. In such examples, the system 100 may comprise the machine-readable storage medium storing the instructions and the processing resource to execute the instructions, or the machine-readable storage medium may be separate but accessible to the system 100 and the processing resource. In other examples, the artificial intelligence reasoning engine 108 may be implemented by electronic circuitry.

In an embodiment, the processor 102 is operatively coupled to one or more non-transitory computer-readable storage media storing instructions that, when executed by the processor 102, cause the processor 102 to perform remote sensing scene classification operations as described herein.

The interface(s) 106 represent communication modules and input/output ports that enable the system 100 to receive remote sensing images, transmit classification results, and interact with external devices or networks, supporting wired or wireless protocols suitable for satellite or UAV data exchange.

In operation, the processor 102 is configured to generate a plurality of test procedures and to determine one or more interaction actions based on one or more input artifacts describing the functional behavior of the DUT. The processor 102 is configured to obtain runtime data describing the state of the DUT using at least one of: a camera-based observation, a screen capture acquisition, an application programming interface (API), one or more telemetry signals, and physical feedback. Examples of the physical feedback include, but are not limited to, buttons, knobs, indicator lights, or haptic inputs. The processor 102 is configured to validate the runtime data to determine the DUT's current state before executing an interaction action. The processor 102 is configured to compare the current state with an expected contextual state. The processor 102 is configured to determine, at runtime, the next interaction action based on the current state and the expected contextual state. The next interaction action is generated without reliance on a predefined test script. The processor 102 is configured to perform one or more interactions with the DUT using an interaction mechanism. The processor 102 is configured to validate an outcome of the one or more interactions based on an updated runtime data. The processor 102 is configured to detect one or more abnormalities or deviations between an expected outcome and an observed outcome. The processor 102 is configured to capture an evidence data corresponding to the one or more abnormalities. The processor 102 is configured to generate a structured report based on the one or more abnormalities and the evidence data.

In an implementation, the processor 102 is further configured to store one or more device interaction parameters and one or more execution outcomes, and adapt the next interaction action based on the one or more abnormalities and the one or more execution outcomes in a continuous closed-loop execution cycle. The processor 102 is further configured to implement a perception-reasoning-action loop comprising an observe-interpret-decide-act-validate-learn cycle. In an embodiment, the processor 102 is further configured to perform object detection, optical character recognition, and interface element classification. In an embodiment, the processor 102 is further configured to select the interaction mechanism based on output from an artificial intelligence reasoning engine. In an embodiment, the processor 102 is configured to enable the artificial intelligence reasoning engine to modify an execution path based on deviations between the expected outcome and the observed outcome.

The database 110 stores datasets, trained model weights, auxiliary classifier parameters, and historical classification results, and interfaces with the artificial intelligence reasoning engine 108 to provide the necessary data for training, validation, and inference. Functionally, the components within system 100 operate in concert to perform verification and validation of human-machine interfaces (HMIs) and other interactive systems by processing input images received via the interface(s) 106 through the processor(s) 102 under the control of the artificial intelligence reasoning engine 108.

In an embodiment, the processor 102 is further configured to store one or more visual references, an interface element metadata, execution logs, and defect evidence. In an embodiment, the interaction mechanism includes a robotic interaction module configured for a physical interaction and a software-simulated interaction module configured for digital interaction. Further, the processor 102 is further configured to utilize stored execution outcomes and anomaly patterns to influence the one or more subsequent interaction actions.

In some embodiments, the processor 102 is configured to receive multimodal input data representing a current state of the DUT. The processor 102 is configured to determine a contextual representation of the current state of the DUT. The processor 102 is configured to validate the contextual representation against one or more expected conditions before execution of an interaction. The processor 102 is configured to generate, at runtime, a next interaction action for the DUT based on the current state. The next interaction action is not derived from a predefined sequence of scripted steps. The processor 102 is configured to execute the next interaction action using an interaction mechanism. The processor 102 is configured to receive an updated multimodal input data corresponding to an outcome of the next interaction action. The processor 102 is configured to evaluate the outcome by comparing the updated multimodal input data with one or more expected outcomes. The processor 102 is configured to detect one or more abnormalities associated with the DUT. The processor 102 is configured to capture an evidence data corresponding to the one or more abnormalities. The processor 102 is configured to generate a structured report based on the one or more abnormalities and the evidence data.

In an embodiment, the processor 102 is configured to store execution data and adapt the next interaction action based on the one or more abnormalities and the execution data in a continuous closed-loop execution cycle.

In an embodiment, the processor 102 is configured to switch between the one or more interaction mechanisms during an execution.

In an embodiment, the processor 102 is configured to record one or more execution outcomes and update a knowledge base with one or more extracted interaction parameters.

In an embodiment, the processor 102 is configured to identify one or more device behavior patterns from the one or more execution outcomes.

In an embodiment, the processor 102 is configured to modify an execution path based on one or more deviations between the one or more expected outcomes and an observed outcome. Examples of the multimodal input data include visual data, interface data, telemetry data, and physical feedback data. Examples of the evidence data include a visual record, an interaction log, and a system data. In an embodiment, the execution data includes contextual representations, interaction actions, outcomes, and detected abnormalities.

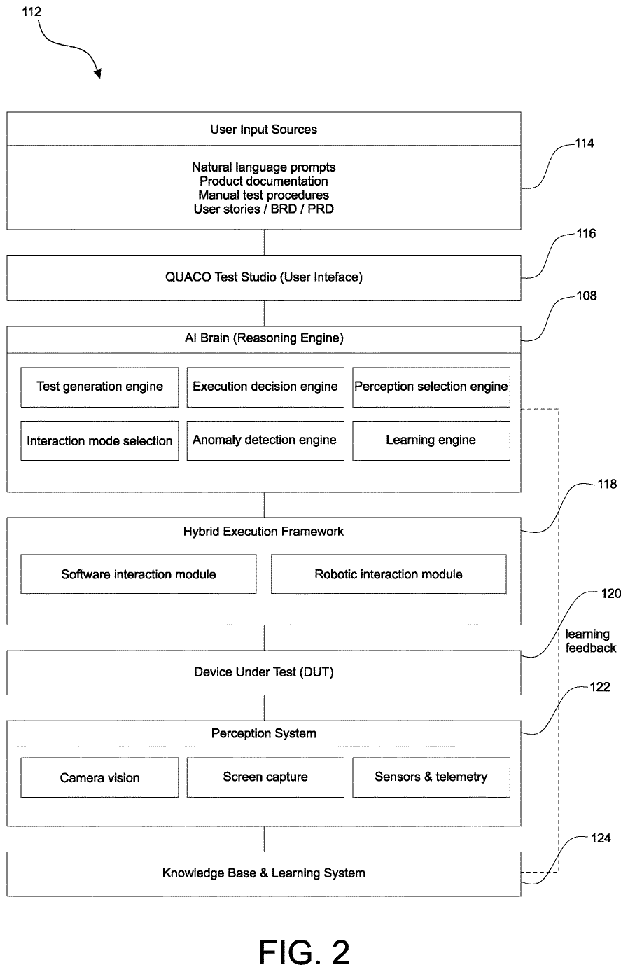

FIG. 2 is a block diagram 112 to illustrate a plurality of user input sources 114, a QUACO test studio 116, an AI reasoning engine or AI brain 108, a hybrid execution framework 118, a device under test 120, a perception system 122, and a knowledge base and learning system 124, according to an embodiment of the present invention. FIG. 2 is explained in conjunction with FIG. 1. In implementation, the system receives inputs from user input sources 114, which may include natural language prompts, product documentation, manual test procedures, and user stories such as BRD or PRD. These inputs are provided to a user interface module, QUACO Test Studio 116, which facilitates interaction between the user and the system. The inputs are processed by an artificial intelligence reasoning engine 108, referred to as the AI Brain, which comprises multiple functional components, including a test generation engine, an execution decision engine, a perception selection engine, an interaction mode selection engine, an anomaly detection engine, and a learning engine. These components collectively enable the generation of test logic, the selection of execution strategies, the determination of perception modalities, the detection of anomalies, and continuous learning.

The AI brain 108 interfaces with a hybrid execution framework 118, which includes a software interaction module and a robotic interaction module. The hybrid execution framework 118 enables interaction with a device under test (DUT) 120 using either software-simulated inputs or physical robotic actions.

The perception system 122 is configured to observe the DUT 120 and includes camera vision, screen capture, and sensor and telemetry inputs. Outputs from the perception system are provided back to the AI Brain and to a knowledge base and learning system 124, which stores execution data and provides learning feedback. A feedback loop enables continuous improvement of system performance through iterative learning.

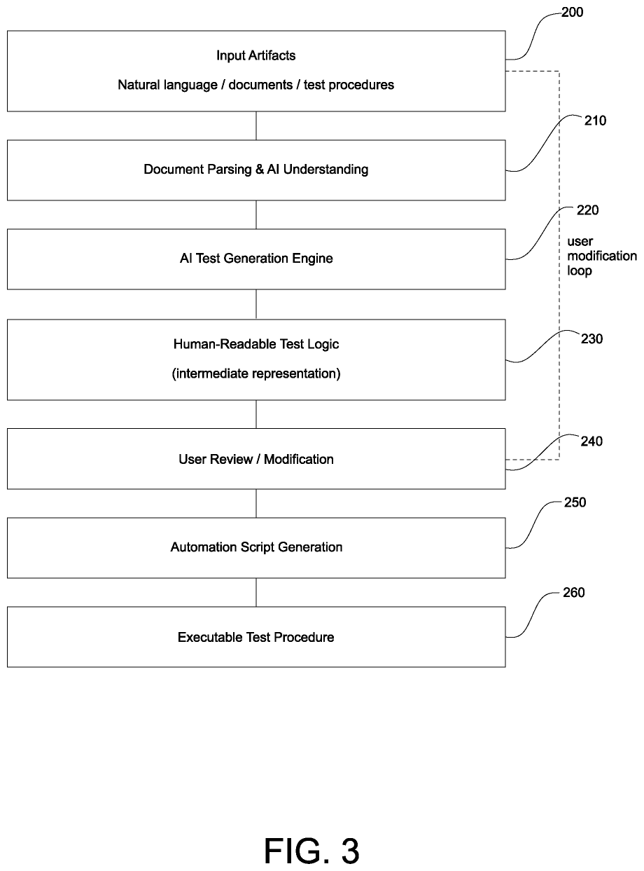

FIG. 3 illustrates an AI-driven test generation pipeline, according to an embodiment of the present invention. The process begins with input artifacts 200, which include natural language inputs, documents, and test procedures. A document parsing and AI understanding module 210 processes these inputs. The processed information is provided to an AI test generation engine 220, which generates a human-readable test logic representation 230. This representation serves as an intermediate format that can be reviewed and modified by a user via a user review and modification stage 240.

Following user validation, the system generates executable automation through an automation script generation module 250, resulting in an executable test procedure 260. A user-modification loop may allow iterative refinement of test logic before execution.

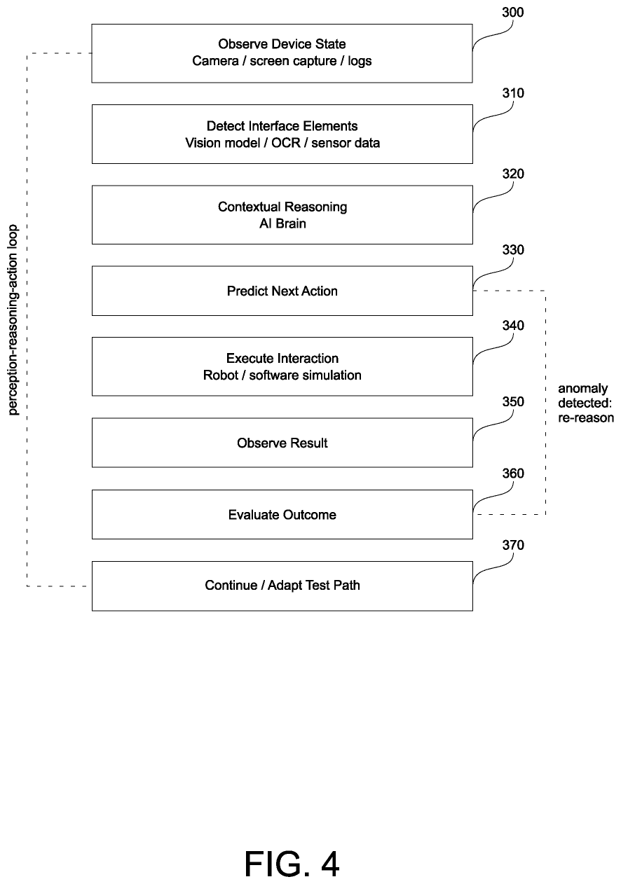

FIG. 4 illustrates a flow diagram of an autonomous test execution loop, according to an embodiment of the present invention. The system begins by observing a device state 300 using camera input, screen capture, or logs. The system then performs interface element detection 310 using vision models, OCR, or sensor data. The AI Brain processes the detected information through contextual reasoning 320. Based on this reasoning, the system predicts the next action 330, which is executed through interaction execution 340 using robotic or software-based mechanisms. Following execution, the system observes a result 350 and performs outcome evaluation 360. Based on the evaluation, the system either continues execution or adapts the test path 370. A continuous perception-reasoning-action loop is maintained. In case of detected anomalies, a re-reasoning loop is triggered to reassess and adjust subsequent actions.

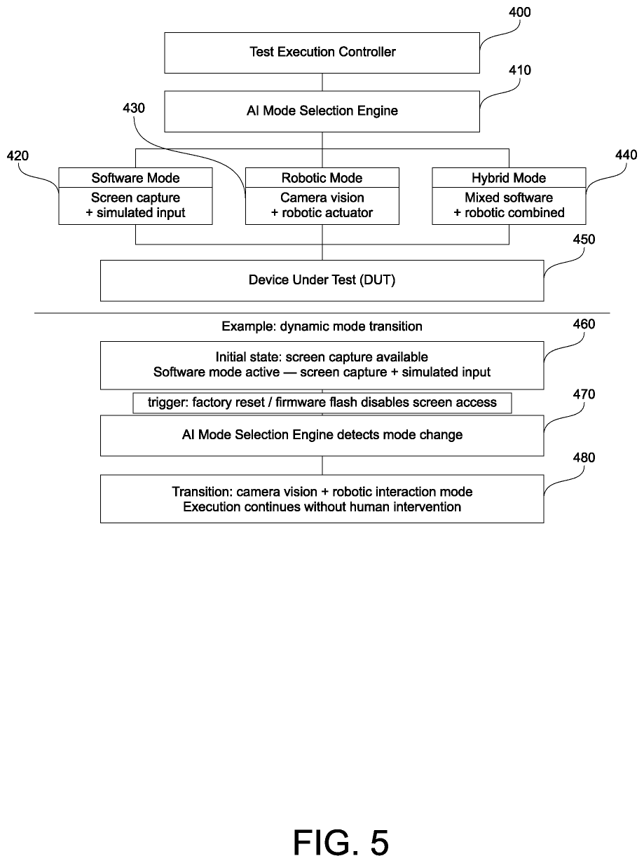

FIG. 5 illustrates a flow diagram of a hybrid interaction mode switching, according to an embodiment of the present invention. A test execution controller 400 operates in conjunction with an AI mode selection engine 410 to determine an appropriate interaction mode. The system may operate in a software mode 420 utilizing screen capture and simulated input, a robotic mode 430 utilizing camera vision and robotic actuators, or a hybrid mode 440 combining both approaches. All modes interact with the device under test 450. An example dynamic transition is illustrated. Initially, in state 460, the system operates in software mode with screen capture and simulated input. Upon occurrence of a trigger event, such as a factory reset or firmware change that restricts screen access, the AI mode selection engine detects the change at 470. The system then transitions at 480 to robotic interaction using camera vision and physical actuation, without requiring human intervention.

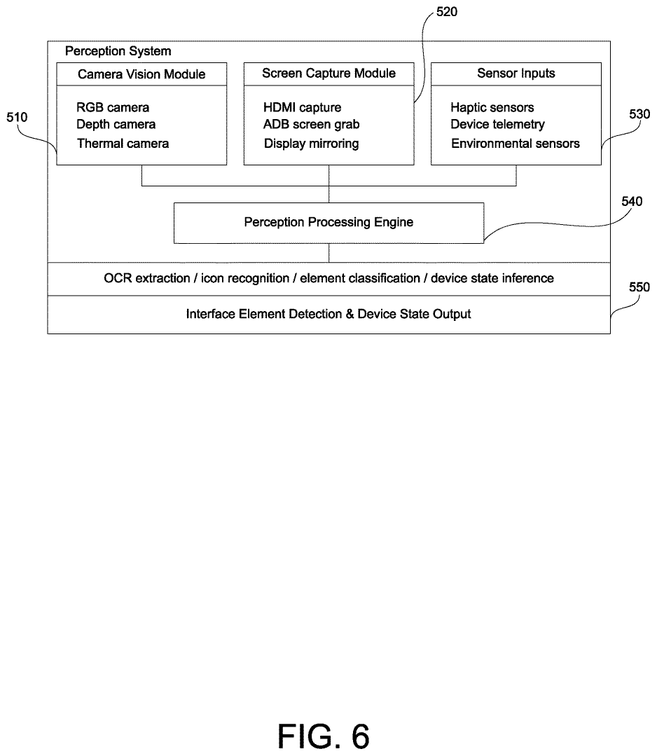

FIG. 6 illustrates a block diagram of a Multimodal perception system, according to an embodiment of the present invention. The perception system includes a camera vision module 510 comprising RGB, depth, and thermal cameras. A screen capture module 520 includes HDMI capture, ADB-based screen capture, and display mirroring mechanisms. A sensor input module 530 includes haptic sensors, device telemetry, and environmental sensors. Inputs from these modules are processed by a perception processing engine 540, which performs operations such as OCR extraction, icon recognition, interface element classification, and device state inference. The processed output is provided as interface element detection and device state output 550. The perception processing engine dynamically selects and fuses inputs from modules 510, 520, and 530 based on operational conditions.

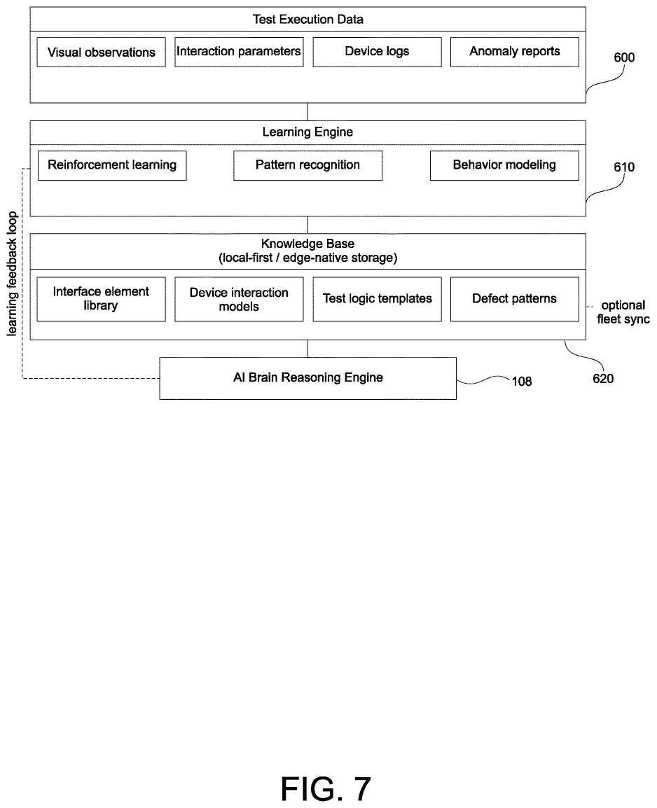

FIG. 7 illustrates a block diagram of a knowledge base and learning architecture, according to an embodiment of the present invention. The system collects and stores test execution data, including visual observations, interaction parameters, device logs, and anomaly reports. A learning engine 610 processes this data using techniques such as reinforcement learning, pattern recognition, and behavior modeling. The processed information is stored within a local knowledge base 620, which serves as a repository of accumulated knowledge. The artificial intelligence reasoning engine 108 enables continuous improvement by refining models and influencing future decision-making based on historical execution outcomes and detected anomalies.

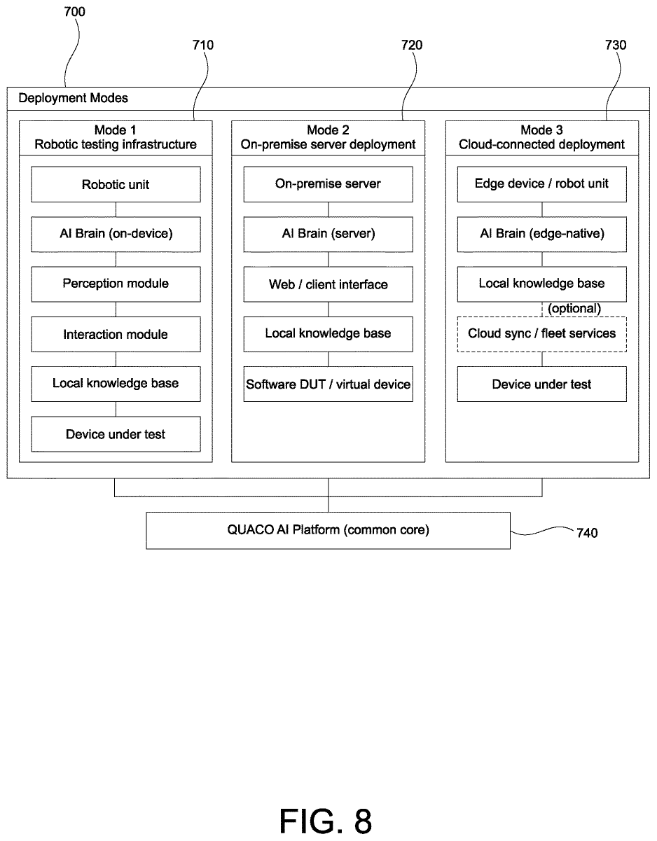

FIG. 8 illustrates a block diagram of a deployment configuration of the present system, according to an embodiment of the present invention. In a first mode 700, a robotic testing infrastructure includes a robotic unit, an AI Brain operating on-device, a perception module, an interaction module, a local knowledge base, and a device under test 710. In a second mode 720, an on-premises server deployment includes an on-premises server, an AI Brain running on the server, a web or client interface, a local knowledge base, and a software-based DUT or virtual device. In a third mode 730, a cloud-connected deployment includes an edge device or robotic unit, an edge-based AI Brain, and a local knowledge base. The system may optionally connect to cloud synchronization or fleet services, enabling data sharing across multiple systems. The system interfaces with a DUT in this configuration as well. A common platform core supports all deployment modes, the QUACO AI platform 740. Cloud connectivity is optional, and the system can operate independently using local resources.

According to an embodiment herein, the present invention includes an integrated architecture configured to perform autonomous verification and validation of interactive systems through coordinated operation of artificial intelligence reasoning, perception, interaction, and learning components. In all embodiments, the architecture includes the artificial intelligence reasoning engine, referred to as the AI Brain, which functions as a central control and orchestration layer of the system. The AI Brain coordinates test planning, perception selection, interaction method selection, test execution control, anomaly detection, structured report generation, and learning operations. In embodiments involving robotic testing infrastructure, the AI Brain operates within a master controller integrated into a robotic testing unit, wherein each robotic testing unit can independently execute testing tasks and optionally communicate with other units or centralized services. In embodiments where physical robotic interaction is not required, the AI Brain operates on a workstation, laptop, personal computer, or on-premise server accessible through a networked interface.

Further, the system includes a perception system configured to observe and interpret the behavior of a device under test. The perception system includes one or more camera vision modules configured to capture visual information of the device under test, including but not limited to RGB cameras, depth cameras, thermal cameras, or other optical sensing mechanisms. The perception system further includes screen capture modules configured to acquire the device under test's display output via mechanisms such as HDMI capture, ADB-based capture, display mirroring, or software-level capture interfaces. The AI Brain dynamically selects between camera-based observation and screen-capture-based observation based on operational conditions, including visibility, accessibility, interaction requirements, and environmental factors.

Furthermore, the system further includes interaction modules configured to interact with the device under test through both physical and virtual mechanisms. In embodiments involving robotic testing infrastructure, physical interaction is performed using robotic interaction modules comprising actuators that apply calibrated, force-controlled interactions to interface elements such as touchscreens, buttons, knobs, sliders, and other controls. The robotic interaction modules may include multi-finger actuators, stylus components, haptic feedback sensors, force control mechanisms, and interchangeable end effectors configured to replicate human interaction. The robotic interaction modules may further support gesture-like spatial interactions and coordination with voice-based interaction peripherals. In certain embodiments, interaction is performed using software-simulated mechanisms, including simulated touch input, keyboard input, pointer movement, gesture simulation, voice stimulus generation, and application programming interface interactions.

In one embodiment, the system operates using a hybrid execution framework in which the AI Brain dynamically determines an observation method and an interaction mechanism based on contextual conditions. The AI Brain may select camera-based observation when direct visual access is available, screen capture when direct digital access is available, robotic interaction for physical interface validation, or software-simulated interaction for efficient functional testing. The AI Brain may dynamically switch between these modes during execution in response to changes in device state, environmental conditions, or testing requirements.

The system further includes a knowledge base and learning system configured to store information generated during testing operations. The knowledge base stores data, including interface element descriptions, interaction parameters, test logic representations, device behavior models, execution history, detected abnormalities, performance data, visual references, and contextual information derived from perception outputs. In preferred embodiments, the knowledge base is maintained locally within the system to reduce latency, preserve operational independence, and maintain confidentiality of device information. The AI Brain updates the knowledge base using execution data through adaptive learning techniques, enabling continuous refinement of decision-making and interaction strategies. In certain embodiments, knowledge sharing across multiple systems may be enabled subject to access control policies.

The system architecture is configurable for deployment in multiple environments. In a robotic infrastructure deployment, one or more robotic testing units each include a master controller, AI Brain, perception system, interaction modules, and a local knowledge base, enabling independent physical testing operations. In an on-premises deployment, the AI Brain and knowledge base run on a local server or computing system within a customer environment, and users access the system via a client or web interface. In a cloud-connected deployment, the system optionally interfaces with cloud infrastructure for centralized model training, data aggregation, or knowledge synchronization, while maintaining local execution and storage capabilities.

The invention further includes an artificial intelligence-driven test-generation engine configured to generate test procedures for the verification and validation of a device under test. The test generation engine operates under the control of the AI Brain and processes input from natural language prompts, documentation, test specifications, historical execution data, and stored knowledge. The system receives input artifacts across various modalities, including natural language, structured and unstructured documents, test scenarios, and previously defined procedures.

In an initial stage of test generation, the AI Brain produces a structured human-readable test logic representation. This representation serves as an intermediate format that includes test identifiers, prerequisites, interaction sequences, expected responses, and validation conditions. The human-readable representation enables review and modification through a user interface before execution. Following validation, the system converts the structured test logic into machine-executable automation instructions, including interaction commands, perception instructions, and validation criteria. The conversion process is performed automatically by the AI Brain.

During execution, the system operates dynamically without relying on predefined scripts. The AI Brain continuously evaluates the state of the device under test using perception outputs, including camera data, screen capture, telemetry signals, and sensor inputs. Based on the observed state, the AI Brain determines subsequent actions, executes interactions, and adapts execution parameters in real time.

The system further performs automated anomaly detection by comparing observed device behavior with expected outcomes. Upon detecting deviations, the system captures supporting evidence, including visual data, logs, and interaction parameters, and generates structured reports describing the detected abnormalities. These reports may be provided to users or integrated with external systems for further processing.

The system supports multiple modes of test creation. In an autonomous mode, the AI Brain generates test logic and automation instructions based on user input without manual scripting. In semi-autonomous mode, user input is used to augment the system's knowledge and refine the generated test logic. In a vision-guided mode, the system presents a visual representation of the device under test, enabling a user to define interactions through a graphical interface, which are then converted into structured test logic and executable instructions.

The system implements an autonomous execution loop in which the AI Brain continuously performs perception, reasoning, action determination, execution, and evaluation. The system observes the device under test's current state, identifies interface elements, determines the next action, executes the action, and evaluates the resulting state. This cycle repeats continuously, enabling adaptive execution based on changing device conditions.

The hybrid execution framework enables the system to operate using multiple interaction modes. The AI Brain selects an interaction mode based on contextual factors, including device capabilities, accessibility, performance requirements, and environmental constraints. During execution, the AI Brain may dynamically transition between interaction modes in response to changes in device state or system conditions. For example, the system may initially use software-simulated interaction and transition to robotic interaction when software-level access becomes unavailable.

The knowledge base and learning system enable continuous improvement of system performance. The system stores execution data, visual references, detected abnormalities, and interaction parameters, and applies adaptive learning techniques to refine future decision-making. The knowledge base is maintained locally to ensure low latency and data security, while optional sharing across systems may be enabled under controlled conditions.

The system is applicable across multiple industry environments. In retail systems, the system verifies point-of-sale devices by combining software and physical interaction. In financial systems, the system tests transaction workflows and secure interfaces. In mobile device environments, the system adapts between software and physical interaction based on device state. In automotive and aviation systems, the system validates complex interface interactions under safety constraints. In medical device environments, the system supports verification of user interfaces while maintaining compliance with data privacy and regulatory requirements.

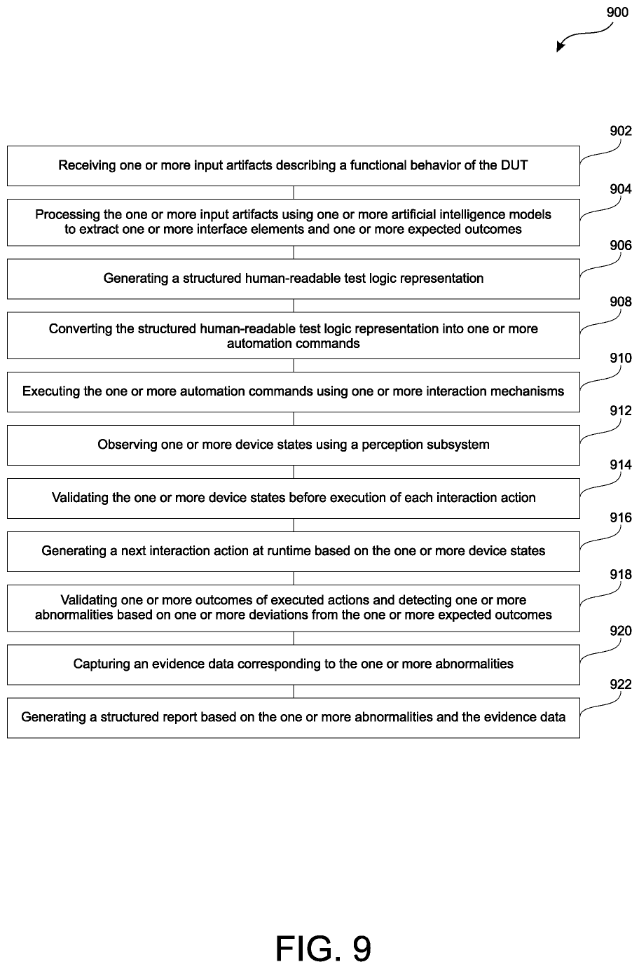

FIG. 9 is a flowchart of a method 900 for automated testing of an interactive device under test (DUT), according to an embodiment of the present invention. The computer-implemented method 900 includes a step 902 of receiving one or more input artifacts that describe the functional behavior of the DUT. The computer-implemented method 900 includes a step 904 of processing the one or more input artifacts using one or more artificial intelligence models to extract one or more interface elements and one or more expected outcomes. The computer-implemented method 900 includes a step 906 of generating a structured human-readable test logic representation. The computer-implemented method 900 includes a step 908 of converting the structured human-readable test logic representation into one or more automation commands. The computer-implemented method 900 includes a step 910 of executing the one or more automation commands using one or more interaction mechanisms. The computer-implemented method 900 includes a step 912 of observing one or more device states using a perception subsystem. The computer-implemented method 900 includes a step 914 of validating the one or more device states before execution of each interaction action. The computer-implemented method 900 includes a step 916 of generating a next interaction action at runtime based on the one or more device states, without executing a predefined script. The computer-implemented method 900 includes a step 918 of validating one or more outcomes of executed actions and detecting one or more abnormalities based on one or more deviations from the one or more expected outcomes. The computer-implemented method 900 includes a step 920 of capturing an evidence data corresponding to the one or more abnormalities. The computer-implemented method 900 includes a step 922 of generating a structured report based on the one or more abnormalities and the evidence data.

In an embodiment, the computer-implemented method includes a step of adapting the next interaction action based on the one or more abnormalities and one or more execution outcomes in a continuous closed-loop execution cycle.

In an embodiment, the computer-implemented method includes a step of switching between the one or more interaction mechanisms during execution.

In an embodiment, the computer-implemented method includes a step of recording one or more execution outcomes and updating a knowledge base with one or more extracted interaction parameters.

In an embodiment, the computer-implemented method includes a step of identifying one or more device behavior patterns from the one or more execution outcomes.

In an embodiment, the computer-implemented method includes a step of modifying an execution path based on the deviations between the one or more expected outcomes and an observed outcome.

In an embodiment, the one or more input artifacts comprise at least one of: a plurality of natural language inputs, a documentation, structured data, and a plurality of manual test procedures.

In an embodiment, processing the input artifacts includes using multiple artificial intelligence models.

In an embodiment, the knowledge base is used to influence subsequent interaction actions.

Unless otherwise defined, all terms (including technical and scientific terms) used in this disclosure have the same meaning as commonly understood by one of ordinary skill in the art to which this disclosure belongs. In this specification, “mobile phone” and “smartphone” are interchangeable, as are “tablet” and “smart tablet.” It is to be understood that the phrases or terms employed by the present invention are for description and not for limitation. As will be appreciated by one of the skills in the art, the present disclosure may be embodied as a device, system, method, or computer program product. Further, the present invention may take the form of a computer program product on a computer-readable storage medium having computer-usable program code embodied in the medium. The present systems and methods have been described above with reference to specific examples. However, other embodiments and examples other than the above description are equally possible within the scope of the present invention. The scope of the disclosure may only be limited by the appended patent claims. Even though modifications and changes may be suggested by the persons skilled in the art, the inventors and applicants intend to embody within the patent warranted hereon all the changes and modifications as reasonably and properly come within the scope of the contribution of the inventors and applicants to the art. The scope of the embodiments of the present invention is ascertained with the claims to be submitted at the time of filing the complete specification. Method steps can be performed in any order unless the context requires otherwise. In the specification and claims, a feature mentioned in the singular (e.g., using “a” or “an”) will be deemed to have an “at least one” or plural construction except where the context indicates such a construction is unworkable. A person of skill in the art will also recognize that the embodiments discussed herein are reconfigurable and within the intended scope. For example, the dependent claims from one independent claim or dependent claim can be similarly made to depend on a different independent claim and/or dependent claim, unless prohibited by the context. In addition, as would be appreciated by a person of skill in the art, certain features or elements of a claim can be mixed and matched with other features or elements, even if not presented together at the time of filing. Similarly, as would be appreciated by a person of skill in the art, data, outputs, and readings from different described sensors, user inputs, and other sources can be used together, even if not presented together at the time of filing. The term “and/or” in a list means all list items present, some list items present, or one of the list items present, unless the context limits such construction. Positional and directional terms described in this specification may be understood to be different from those shown or described and should not limit the variations of embodiments possible from the claimed features that a person of ordinary skill in the art would understand from the specification, figures, and claims.

I/We claim:

1. A system for autonomous verification and validation of an interactive device under test (DUT), comprising:
a processor configured to:
generate a plurality of test procedures and determine one or more interaction actions based on one or more input artifacts describing a functional behavior of the DUT;
obtain a runtime data describing a state of the DUT using at least one of: a camera-based observation, a screen capture acquisition, an application programming interface (API), one or more telemetry signals, and a physical feedback;
validate the runtime data to determine a current state of the DUT before execution of an interaction action;
compare the current state with an expected contextual state;
determine a next interaction action based on the current state and the expected contextual state;
perform one or more interactions with the DUT using an interaction mechanism;
validate an outcome of the one or more interactions based on an updated runtime data;
detect one or more abnormalities between an expected outcome and an observed outcome;
capture an evidence data corresponding to the one or more abnormalities; and
generate a structured report based on the one or more abnormalities and the evidence data.

2. The system of claim 1, wherein the processor is further configured to:
store one or more device interaction parameters and one or more execution outcomes; and
adapt the next interaction action based on the one or more abnormalities and the one or more execution outcomes in a continuous closed-loop execution cycle.

3. The system of claim 1, wherein the processor is further configured to implement a perception-reasoning-action loop comprising an observe-interpret-decide-act-validate-learn cycle.

4. The system of claim 1, wherein the processor is further configured to perform object detection, optical character recognition, and interface element classification.

5. The system of claim 1, wherein the processor is further configured to select the interaction mechanism based on output from an artificial intelligence reasoning engine.

6. The system of claim 5, wherein the processor is configured to enable the artificial intelligence reasoning engine to modify an execution path based on deviations between the expected outcome and the observed outcome.

7. A computer-implemented method for automated testing of an interactive device under test (DUT), comprising:
receiving one or more input artifacts describing a functional behavior of the DUT;
processing the one or more input artifacts using one or more artificial intelligence models to extract one or more interface elements and one or more expected outcomes;
generating a structured human-readable test logic representation;
converting the structured human-readable test logic representation into one or more automation commands;
executing the one or more automation commands using one or more interaction mechanisms;
observing one or more device states using a perception subsystem;
validating the one or more device states before execution of each interaction action;
generating a next interaction action at runtime based on the one or more device states;
validating one or more outcomes of executed actions and detecting one or more abnormalities based on one or more deviations from the one or more expected outcomes;
capturing an evidence data corresponding to the one or more abnormalities; and
generating a structured report based on the one or more abnormalities and the evidence data.

8. The computer-implemented method of claim 7, further comprising adapting the next interaction action based on the one or more abnormalities and one or more execution outcomes in a continuous closed-loop execution cycle.

9. The computer-implemented method of claim 7, further comprising switching between the one or more interaction mechanisms during an execution.

10. The computer-implemented method of claim 7, further comprising recording one or more execution outcomes and updating a knowledge base with one or more extracted interaction parameters.

11. The computer-implemented method of claim 10, further comprising identifying one or more device behavior patterns from the one or more execution outcomes.

12. The computer-implemented method of claim 7, further comprising modifying an execution path based on the deviations between the one or more expected outcomes and an observed outcome.

13. A system for autonomous interaction with and evaluation of a device under test (DUT), comprising:
a processor configured to:
receive a multimodal input data representing a current state of the DUT;
determine a contextual representation of the current state of the DUT;
validate the contextual representation against one or more expected conditions before execution of an interaction;
generate a next interaction action for the DUT based on the current state;
execute the next interaction action using an interaction mechanism;
receive an updated multimodal input data corresponding to an outcome of the next interaction action;
evaluate the outcome by comparing the updated multimodal input data with one or more expected outcomes;
detect one or more abnormalities associated with the DUT;
capture an evidence data corresponding to the one or more abnormalities; and
generate a structured report based on the one or more abnormalities and the evidence data.

14. The system of claim 13, wherein the processor is configured to:
store an execution data; and
adapt the next interaction action based on the one or more abnormalities and the execution data in a continuous closed-loop execution cycle.

15. The system of claim 13, wherein the processor is configured to switch between the one or more interaction mechanisms during an execution.

16. The system of claim 13, wherein the processor is configured to record one or more execution outcomes and update a knowledge base with one or more extracted interaction parameters.

17. The system of claim 16, wherein the processor is configured to identify one or more device behavior patterns from the one or more execution outcomes.

18. The system of claim 13, wherein the processor is configured to modify an execution path based on one or more deviations between the one or more expected outcomes and an observed outcome.

19. The system of claim 13, wherein the multimodal input data comprises: a visual data, an interface data, a telemetry data, and a physical feedback data.

20. The system of claim 13, wherein the evidence data comprises a visual record, an interaction log, and a system data.
